(19) United States
(12) Patent Application Publication
(10) Pub. No.: US 2018/0180959 A1
(43) Pub. Date: Jun. 28, 2018

(54) PANEL INSPECTION CIRCUIT AND LIQUID CRYSTAL DISPLAY PANEL

(71) Applicant: SHENZHEN CHINA STAR OPTOELECTRONICS TECHNOLOGY CO. LTD., Guangdong (CN)

(72) Inventor: Qiming GAN, Guangdong (CN)

(21) Appl. No.: 15/312,447

(22) PCT Filed: Jun. 3, 2016
(86) PCT No.: PCT/CN2016/084743

§ 371 Date: Nov. 18, 2016

(30) Foreign Application Priority Data
Apr. 21, 2016 (CN) 201610255153.X

(51) Int. Cl. G02F 1/1362; G02F 1/1368; G02F 1/133

(52) U.S. Cl. CPC G02F 1/136286; G02F 2001/136254; G02F 1/13306; G02F 1/1368

(57) ABSTRACT

A panel inspection circuit is provided and includes: multiple data signal lines; multiple testing switches; multiple testing lines including: a first testing line, a second testing line and a third testing line; and multiple control lines including a first control line, a second control line and a third control line; the first control line is used to turn on the testing switches which are connected to the first testing line; the second control line is used to turn on the testing switches which are connected to the second testing line; the third control line is used to turn on the testing switches which are connected to the third testing line.

### BACKGROUND OF THE INVENTION

### Field of the Invention

The present invention relates to the technical field of inspection circuit, and more particularly to a panel inspection circuit and a liquid crystal display panel having the same.

### Description of the Related Art

A liquid crystal display (LCD) is one of the most widely used flat panel displays and may be applied in a laptop computer or a mobile phone. Because of the market demand, the manufacturing process of LCD or the design for its panel structure is continuously developed and improved. In order to ensure the display quality of LCD products, it is necessary to inspect or test liquid crystal display panels so as to find out defective panels in advance, and thereby reducing the cost of a follow-up manufacturing process.

At present, in the inspection for liquid crystal display panels, test lines are usually mounted on an array substrate of a liquid crystal display panel to connect signal lines in the liquid crystal display panel. As shown in FIG. 1, the liquid crystal display panel to be inspected has red sub-pixels, green sub-pixels and blue sub-pixels. When inspecting the liquid crystal display panel, a red sub-pixel testing signal, a greed sub-pixel testing signal and a blue sub-pixel testing signal will be inputted to the liquid crystal display panel via a red sub-pixel testing line 103, a green sub-pixel testing line 102 and a blue sub-pixel testing line 101. In a data end, the blue sub-pixel testing signal is inputted to a data signal line via the blue sub-pixel testing line 101; in the meantime, since there an overlapping area between the data signal line and the green sub-pixel testing line 102 and another overlapping are between the data signal line and the red sub-pixel testing line 103, a short circuit might occur in these two overlapping areas (104, 105). When a short circuit occurs in one of the overlapping areas, the blue sub-pixel testing signal inputted by the blue sub-pixel testing line 101 will be transmitted to other data signal lines, thereby being unable to determine if there are any abnormal problems in a display area of the panel. Similarly, the green sub-pixel testing signal is inputted to another data signal line via the green sub-pixel testing line 102; in the meantime, since there an overlapping area 106 between the data signal line and the red sub-pixel testing line 103, a short circuit might occur in this overlapping area 106 during the manufacturing process, then the green sub-pixel testing signal inputted by the green sub-pixel testing line 102 will be transmitted to other data signal lines, thereby being unable to determine if there are any abnormal problems in the display area of the panel.

Once a short circuit occurs in the overlapping areas, the inspection process will not be able to proceed. Hence, it is necessary to provide a panel inspection circuit to overcome the problems existing in the conventional technology.

### SUMMARY OF THE INVENTION

The present invention provides a panel inspection circuit which is able to effectively solve the technical problem existing in the conventional technology where an inspection process cannot proceed when a short circuit occurs in overlapping areas of signal lines and testing lines.

In order to solve the foregoing problem, the present invention provides a panel inspection circuit including:

multiple data signal lines;

multiple testing switches being connected to the data signal lines, respectively; wherein the testing switches are thin-film transistors;

multiple testing lines being connected to the testing switches, and including: a first testing line for inputting a red sub-pixel testing signal to the testing switches; a second testing line for inputting a green sub-pixel testing signal to the testing switches; and a third testing line for inputting a blue sub-pixel testing signal to the testing switches; and

multiple control lines being connected to the testing switches, and including a first control line, a second control line and a third control line; wherein the first control line is used to turn on the testing switches which are connected to the first testing line; the second control line is used to turn on the testing switches which are connected to the second testing line; the third control line is used to turn on the testing switches which are connected to the third testing line.

Each of the testing switches has a source, a drain and a gate; the source is connected to a corresponding one of the testing lines; the drain is connected to a corresponding one of the data signal lines; and the gate is connected to a corresponding one of the control lines.

The testing signal inputted by each of the testing lines has a lowest display electric potential value.

Each of the testing switches has a lowest activating electric potential value; the lowest activating electric potential value is lower than the lowest display electric potential value.

The panel inspection circuit further includes a driving circuit assembly mounted on a substrate; wherein the driving circuit assembly is electrically connected the data signal lines.

Each of the data signal lines has a metal terminal used to receive the corresponding testing signal.

The present invention further provides a panel inspection circuit including:

multiple data signal lines;

multiple testing switches being connected to the data signal lines, respectively;

multiple testing lines being connected to the testing switches, and including: a first testing line for inputting a red sub-pixel testing signal to the testing switches; a second testing line for inputting a green sub-pixel testing signal to the testing switches; and a third testing line for inputting a blue sub-pixel testing signal to the testing switches; and

multiple control lines being connected to the testing switches, and including a first control line, a second control line and a third control line; wherein the first control line is used to turn on the testing switches which are connected to the first testing line; the second control line is used to turn on the testing switches which are connected to the second testing line; the third control line is used to turn on the testing switches which are connected to the third testing line.

The testing switches are thin-film transistors.

Each of the testing switches has a source, a drain and a gate; the source is connected to a corresponding one of the testing lines; the drain is connected to a corresponding one of the data signal lines; and the gate is connected to a corresponding one of the control lines.

The testing signal inputted by each of the testing lines has a lowest display electric potential value.

Each of the testing switches has a lowest activating electric potential value; the lowest activating electric potential value is lower than the lowest display electric potential value.

The panel inspection circuit further includes a driving circuit assembly mounted on a substrate; wherein the driving circuit assembly is electrically connected the data signal lines.

Each of the data signal lines has a metal terminal used to receive the corresponding testing signal.

The present invention further provides a liquid crystal display panel including a panel inspection circuit, and the panel inspection circuit has:

multiple data signal lines;

multiple testing switches being connected to the data signal lines, respectively;

multiple testing lines being connected to the testing switches, and including: a first testing line for inputting a red sub-pixel testing signal to the testing switches; a second testing line for inputting a green sub-pixel testing signal to the testing switches; and a third testing line for inputting a blue sub-pixel testing signal to the testing switches; and

multiple control lines being connected to the testing switches, and including a first control line, a second control line and a third control line; wherein the first control line is used to turn on the testing switches which are connected to the first testing line; the second control line is used to turn on the testing switches which are connected to the second testing line; the third control line is used to turn on the testing switches which are connected to the third testing line.

The testing signal inputted by each of the testing lines has a lowest display electric potential value.

Each of the testing switches has a lowest activating electric potential value; the lowest activating electric potential value is lower than the lowest display electric potential value.

The panel inspection circuit provided by the present invention is to mount multiple testing switches on data signal lines, and then use multiple control lines to control the testing switches, so that the inspection for the panel can still proceed when there is a short circuit occurring at an overlapping area between the lines. Besides, after the inspection process, it is not necessary to cut off the testing line by laser. Thus, an additional laser cutting step can be avoided. Furthermore, the testing switches and active elements of pixels can be formed at the same time without additional manufacturing steps.

### BRIEF DESCRIPTION OF THE DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic view of a conventional panel inspection circuit; and

FIG. 2 is a schematic view of a panel inspection circuit according to an embodiment of the present invention.

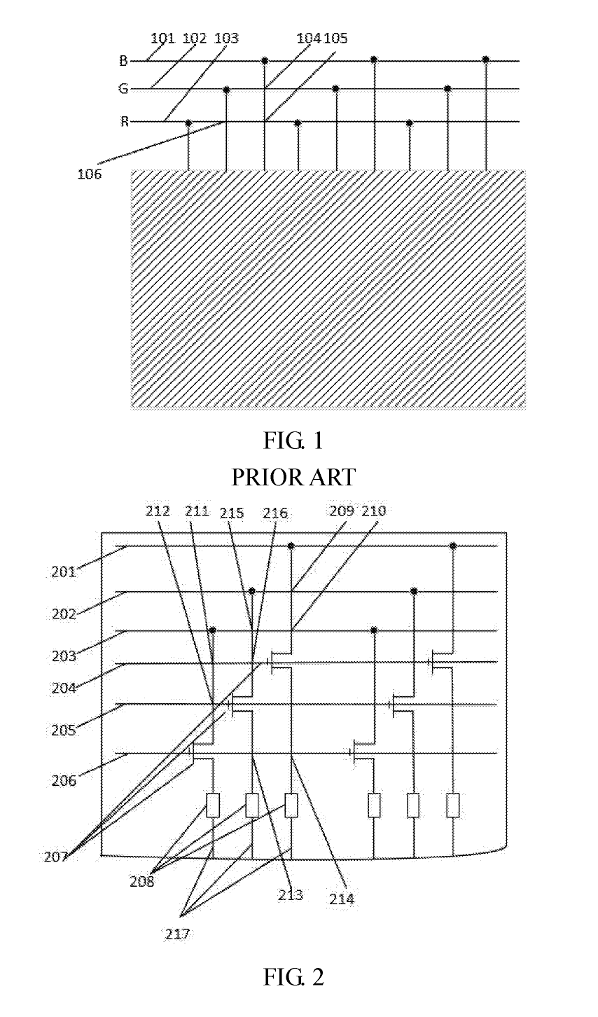

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto. In the drawings, similar structural units are designated by the same reference numerals.

The preferred embodiments of the present invention are described in detail in cooperation with accompanying drawings as follows.

Please refer to FIG. 2, a schematic view of a panel inspection circuit according to an embodiment of the present invention.

The panel inspection circuit of the embodiment includes:

multiple data signal lines 217; multiple testing switches 207 being connected to the data signal lines 217; multiple testing lines being connected to the testing switches 207 and including: a first testing line 203 for inputting a red sub-pixel testing signal to the testing switches 207; a second testing line 202 for inputting a green sub-pixel testing signal to the testing switches 207; and a third testing line 201 for inputting a blue sub-pixel testing signal to the testing switches 207; and multiple control lines being connected to the test switches 207 and including: a first control line 206, a second control line 205 and a third control line 204; wherein the first control line 206 is used to turn on the testing switches 207 which are connected to the first testing line 203; the second control line 205 is used to turn on the testing switches 207 which are connected to the second testing line 202; the third control line 204 is used to turn on the testing switches 207 which are connected to the third testing line 201.

In this embodiment, each of the data signal lines 217 has an external input terminal 208 which is used to receive inputted signals. The input terminal 208 is mounted at a side of the data signal lines 217 and connected to the corresponding testing switch 207.

The testing switches 207 are connected between the input terminals 208 of the data signal lines 217 and the testing lines, and may be turned on or off when inspecting the liquid crystal display panel so as to allow the testing signals to be transmitted to the data signal lines 217 via the testing lines or to prevent the testing signals from being transmitted to the data signal lines 217 via the testing lines. The testing switches 207 may be thin-film transistors. In this case, each of the testing switches 207 has a source, a drain and a gate. The source is connected to a corresponding one of the testing lines. The drain is connected to a corresponding one of the data signal lines 217. The gate is connected to a corresponding one of the control lines. In this embodiment, the testing switches and active elements of the liquid crystal display panel may be formed on a substrate at the same time so as to avoid additional manufacturing steps. That is, during the manufacturing process of the active elements of the liquid crystal display panel, the active elements and the testing switches can be simultaneously formed on the substrate. Therefore, it does not require additional manufacturing steps for forming the testing switches 207.

The testing lines are connected to the testing switches 207 and are used to input testing signals to the data signal lines 217. An external testing unit or a testing system may provide the testing signals through the testing lines to the data signal lines 217. In this embodiment, the data signal lines 217 includes at least one red sub-pixel signal lines, at least one green sub-pixel signal lines and at least one blue sub-pixel signal lines. A data terminal of the liquid crystal display panel may be provided with three testing lines which include: a first testing line 203, a second testing line 202 and a third testing line 201. The first testing line 203 is used to input a red sub-pixel testing signal to the testing switches 207. The second testing line 202 is used to input a green sub-pixel testing signal to the testing switches 207. The third testing line 201 is used to input a blue sub-pixel testing signal to the testing switches 207.

The control lines are respectively connected to the testing switches 207 and are used to input control signals to the testing switches 207 to turn on the switches when testing the liquid crystal display panel. In this embodiment, the panel inspection circuit is provided with three control lines which include a first control line 206, a second control line 205 and a third control line 204; wherein the first control line 206 is used to turn on the testing switches 207 which are connected to the first testing line 203; the second control line 205 is used to turn on the testing switches 207 which are connected to the second testing line 202; the third control line 204 is used to turn on the testing switches 207 which are connected to the third testing line 201.

When testing if blue sub-pixels of the liquid crystal display panel are normal, a testing signal will be inputted to the blue sub-pixel signal lines through the third testing line 201. In the meantime, a control signal is inputted by the third control line 204 to the testing switches 207 which are connected to the blue sub-pixel signal lines so that the testing switches 207 connected to the blue sub-pixel signal lines are turned on. Meanwhile, the testing switches 207 which are connected to the red sub-pixel signal lines and the testing switches 207 which are connected to the green sub-pixel signal lines are all turned off When there is a short circuit occurring at a first overlapping area 209 and a second overlapping area 210, since the testing switches 207 which are connected to the red sub-pixel signal lines and the testing switches 207 which are connected to the green sub-pixel signal lines are all turned off, the testing signal will not be transmitted to the data signal lines 217 through these testing switches 207, therefore the inspection for the panel can still proceed.

When testing if red sub-pixels of the liquid crystal display panel are normal, a testing signal will be inputted to the red sub-pixel signal lines through the first testing line 203. In the meantime, a control signal is inputted by the first control line 206 to the testing switches 207 which are connected to the red sub-pixel signal lines so that the testing switches 207 connected to the red sub-pixel signal lines are turned on. Meanwhile, the testing switches 207 which are connected to the blue sub-pixel signal lines and the testing switches 207 which are connected to the green sub-pixel signal lines are all turned off. When there is a short circuit occurring at a third overlapping area 211 and a fourth overlapping area 212, the testing switches 207 which are connected to the blue sub-pixel signal lines and the testing switches 207 which are connected to the green sub-pixel signal lines will all be turned on. However, in the meantime, there are no testing signals being inputted to the third testing line 201 and the second testing line 202; thus, the inspection for the panel can still proceed. The testing signal has a lowest electric potential value; that is, only when an electric potential value of the testing signal is higher the lowest electric potential value, the liquid crystal display panel will be able to display images. Besides, an activating electric potential value of the testing switches is lower than the lowest electric potential value; that is, even if there is a short circuit occurring at a fifth overlapping area 213 and a sixth overlapping area 214, an activating electric potential value of the control signal would not be enough for activating the liquid crystal display panel to display images since the activating electric potential value of the testing switches is lower than the lowest electric potential value, and thus the inspection of the panel can still proceed.

When testing if green sub-pixels of the liquid crystal display panel are normal, a testing signal will be inputted to the green sub-pixel signal lines through the second testing line 202. In the meantime, a control signal is inputted by the second control line 205 to the testing switches 207 which are connected to the green sub-pixel signal lines so that the testing switches 207 connected to the green sub-pixel signal lines are turned on. Meanwhile, the testing switches 207 which are connected to the blue sub-pixel signal lines and the testing switches 207 which are connected to the red sub-pixel signal lines are all turned off. When there is a short circuit occurring at a seventh overlapping area 215, since the testing switches 207 which are connected to the red sub-pixel signal lines are turned off, the testing signal will not be transmitted to the data signal lines 217 through these testing switches 207, therefore the inspection for the panel can still proceed. The testing signal has a lowest electric potential value; that is, only when an electric potential value of the testing signal is higher the lowest electric potential value, the liquid crystal display panel will be able to display images. Besides, an activating electric potential value of the testing switches is lower than the lowest electric potential value. When there is a short circuit occurring at an eighth overlapping area 216, the testing switches 207 connected to the red sub-pixel signal lines are turned on; however, there will be no testing signals inputted to the first testing line 203 since an activating electric potential value of the control signal is lower than the lowest electric potential value, and therefore the inspection of the panel can still proceed.

After the inspection process of the liquid crystal display panel, the inputting of control signals to the control lines will be stopped to turn off the testing switches 207, so that the testing signals will not be transmitted to the data signal lines 217 through the testing lines. Thus, by using the testing switches 207, the paths between the testing lines and the data signal lines 217 can be directly blocked without having to cut off the testing lines by laser, thereby an additional laser cutting step can be avoided.

When the liquid crystal display panel has been through the inspection process and been confirmed as normal, a driving circuit assembly may be mounted on a non-display area of the substrate (i.e. an outer side of the data signal lines 217) for providing signals to the data signal lines 217. In this case, the electrical connecting terminals of the driving circuit assembly may be directly bonded to the input terminals 208 so that the driving circuit assembly can be electrically connected to the data signal lines 217. After the inspection process of the liquid crystal display panel, since the testing switches 207 between the data signal lines 217 and the testing lines are all turned off, the driving circuit assembly can be directly bonded on the input terminals 208 of the data signal lines 217 and the testing lines can still remain on the inspected liquid crystal display panel without having to be cut off. An additional laser cutting step can be avoided.

The panel inspection circuit provided by the present invention is to mount multiple testing switches on signal lines, and then use multiple control lines to control the testing switches, so that the inspection process for the panel can still proceed when there is a short circuit occurring at an overlapping area between the lines. Besides, after the inspection process, it is not necessary to cut off the testing line by laser. Thus, an additional laser cutting step can be avoided. Furthermore, the testing switches and active elements of pixels can be formed at the same time without additional manufacturing steps.

In conclusion, although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A panel inspection circuit, comprising:
multiple data signal lines;
multiple testing switches being connected to the data signal lines, respectively; wherein the testing switches are thin-film transistors;
multiple testing lines being connected to the testing switches, and including: a first testing line for inputting a red sub-pixel testing signal to the testing switches; a second testing line for inputting a green sub-pixel testing signal to the testing switches; and a third testing line for inputting a blue sub-pixel testing signal to the testing switches; and
multiple control lines being connected to the testing switches, and including a first control line, a second control line and a third control line; wherein the first control line is used to turn on the testing switches which are connected to the first testing line; the second control line is used to turn on the testing switches which are connected to the second testing line; the third control line is used to turn on the testing switches which are connected to the third testing line.

2. The panel inspection circuit as claimed in claim 1, wherein each of the testing switches has a source, a drain and a gate; the source is connected to a corresponding one of the testing lines; the drain is connected to a corresponding one of the data signal lines; and the gate is connected to a corresponding one of the control lines.

3. The panel inspection circuit as claimed in claim 2, wherein the testing signal inputted by each of the testing lines has a lowest display electric potential value.

4. The panel inspection circuit as claimed in claim 3, wherein each of the testing switches has a lowest activating electric potential value; the lowest activating electric potential value is lower than the lowest display electric potential value.

5. The panel inspection circuit as claimed in claim 4, wherein the panel inspection circuit further comprises a driving circuit assembly mounted on a substrate; wherein the driving circuit assembly is electrically connected the data signal lines.

6. The panel inspection circuit as claimed in claim 5, wherein each of the data signal lines has a metal terminal used to receive the corresponding testing signal.

7. A panel inspection circuit, comprising:
multiple data signal lines;
multiple testing switches being connected to the data signal lines, respectively;
multiple testing lines being connected to the testing switches, and including: a first testing line for inputting a red sub-pixel testing signal to the testing switches; a second testing line for inputting a green sub-pixel testing signal to the testing switches; and a third testing line for inputting a blue sub-pixel testing signal to the testing switches; and
multiple control lines being connected to the testing switches, and including a first control line, a second control line and a third control line; wherein the first control line is used to turn on the testing switches which are connected to the first testing line; the second control line is used to turn on the testing switches which are connected to the second testing line; the third control line is used to turn on the testing switches which are connected to the third testing line.

8. The panel inspection circuit as claimed in claim 7, wherein the testing switches are thin-film transistors.

9. The panel inspection circuit as claimed in claim 8, wherein each of the testing switches has a source, a drain and a gate; the source is connected to a corresponding one of the testing lines; the drain is connected to a corresponding one of the data signal lines; the gate is connected to a corresponding one of the control lines.

10. The panel inspection circuit as claimed in claim 9, wherein the testing signal inputted by each of the testing lines has a lowest display electric potential value.

11. The panel inspection circuit as claimed in claim 10, wherein each of the testing switches has a lowest activating electric potential value; the lowest activating electric potential value is lower than the lowest display electric potential value.

12. The panel inspection circuit as claimed in claim 11, wherein the panel inspection circuit further comprises a driving circuit assembly mounted on a substrate; wherein the driving circuit assembly is electrically connected the data signal lines.

13. The panel inspection circuit as claimed in claim 12, wherein each of the data signal lines has a metal terminal used to receive the corresponding testing signal.

14. A liquid crystal display panel comprising a panel inspection circuit, wherein the panel inspection circuit includes:
multiple data signal lines;
multiple testing switches being connected to the data signal lines, respectively;
multiple testing lines being connected to the testing switches, and including: a first testing line for inputting a red sub-pixel testing signal to the testing switches; a second testing line for inputting a green sub-pixel testing signal to the testing switches; and a third testing line for inputting a blue sub-pixel testing signal to the testing switches; and
multiple control lines being connected to the testing switches, and including a first control line, a second control line and a third control line; wherein the first control line is used to turn on the testing switches which are connected to the first testing line; the second control line is used to turn on the testing switches which are connected to the second testing line; the third control line is used to turn on the testing switches which are connected to the third testing line.

15. The liquid crystal display panel as claimed in claim 14, wherein the testing switches are thin-film transistors.

16. The liquid crystal display panel as claimed in claim 15, wherein each of the testing switches has a source, a drain and a gate; the source is connected to a corresponding one of the testing lines; the drain is connected to a corresponding one of the data signal lines; and the gate is connected to a corresponding one of the control lines.

17. The liquid crystal display panel as claimed in claim 16, wherein the testing signal inputted by each of the testing lines has a lowest display electric potential value.

18. The liquid crystal display panel as claimed in claim 17, wherein each of the testing switches has a lowest activating electric potential value; the lowest activating electric potential value is lower than the lowest display electric potential value.

19. The liquid crystal display panel as claimed in claim 18, wherein the panel inspection circuit further includes a driving circuit assembly mounted on a substrate; wherein the driving circuit assembly is electrically connected the data signal lines.

20. The liquid crystal display panel as claimed in claim 19, wherein each of the data signal lines has a metal terminal used to receive the corresponding testing signal.
